(19) United States
(12) Patent Application Publication
(10) Pub. No.: US 2022/0011958 A1
(43) Pub. Date: Jan. 13, 2022

(54) RUNTIME QUANTUM-MEMORY REMAPPING

(71) Applicant: ColdQuanta, Inc., Boulder, CO (US)

(72) Inventor: Clifton Leon ANDERSON, Patterson, CA (US)

(21) Appl. No.: 17/146,778

(22) Filed: Jan. 12, 2021

Related U.S. Application Data
(60) Provisional application No. 63/049,242, filed on Jul. 8, 2020.

(51) Int. Cl. G06F 3/06; G06N 10/00

(52) U.S. Cl. CPC G06F 3/0638; G06F 3/0671; G06F 3/0604; G06N 10/00

(57) ABSTRACT

A quantum circuit program, when executed, implements a quantum circuit in quantum memory. The quantum-circuit program specifies addresses of quantum memory locations. A runtime quantum-memory remapper can route program instructions to the memory addresses they specify or to other memory locations between the time execution of the quantum circuit begins and the time that quantum-circuit execution is completed. The remapping can take place in response to a detection of a condition in which a memory location used by the quantum circuit becomes faulty, e.g., because it lost its quantum-state carrier. Remapping the quantum circuit allows its execution to continue despite the problem with quantum memory, and, in some cases, continue during the remedying of the remapping condition.

### BACKGROUND

While classical digital computers manipulate bits of information, quantum. computers manipulate qubits. Both classical bits and quantum qubits can be represented physically using two-state carriers. Examples of two-state quantum carriers include an electron that can assume a spin up state and a spin down state, and an electron in an atom that can assume either of two excitation states. A classical two-state carrier assumes one or the other of the two states at any given time; a quantum two-state carrier can be in a coherent superposition of both states simultaneously. The phenomenon of quantum. superposition is key to the ability of quantum computers to solve some problems much faster than they can be solved using classical computers.

Superposition states can be quite fragile in that a quantum-state carrier (QSC) can fall out of superposition spontaneously or in response to an unintentional perturbation, Furthermore, a quantum memory can lose one or more QSCs along with the information they contained. The loss of a QSC, even one that contains no useful information, prevents its use in subsequent operations. In some cases, this can halt progress in a quantum computation. In principle, a lost QSC can be replaced and its state restored using error-correction; however existing approaches to QSC replacement and error correction have yet to prove their practicability for use during runtime.

### BRIEF DESCRIPTION OF THE DRAWINGS

FIG. 1 is a schematic diagram of a quantum computing system.

FIGS. 2A-2D are schematic diagrams showing various mappings between addresses specified by a quantum-circuit program and physical locations of a quantum memory.

FIG. 3 is a schematic diagram of a quantum memory of the quantum computing system of FIG. 1 and representing transfer of a quantum state using a series of state-swap operations.

FIG. 4 is a comparative diagram of a default circuit mapping and eight different remappings of the default circuit mapping.

FIG. 5 is a detailed schematic of a runtime-remapper in the context of other components of the quantum computer system of FIG. 1.

FIG. 6 is a detailed schematic of a transpiler and a quantum-circuit program shown in context with a quantum-assembly language circuit program of the quantum computer system of FIG. 1.

FIG. 7 is a flow chart of a runtime quantum-memory remapping process implementable in the quantum computer system of FIG. 1 and in other systems.

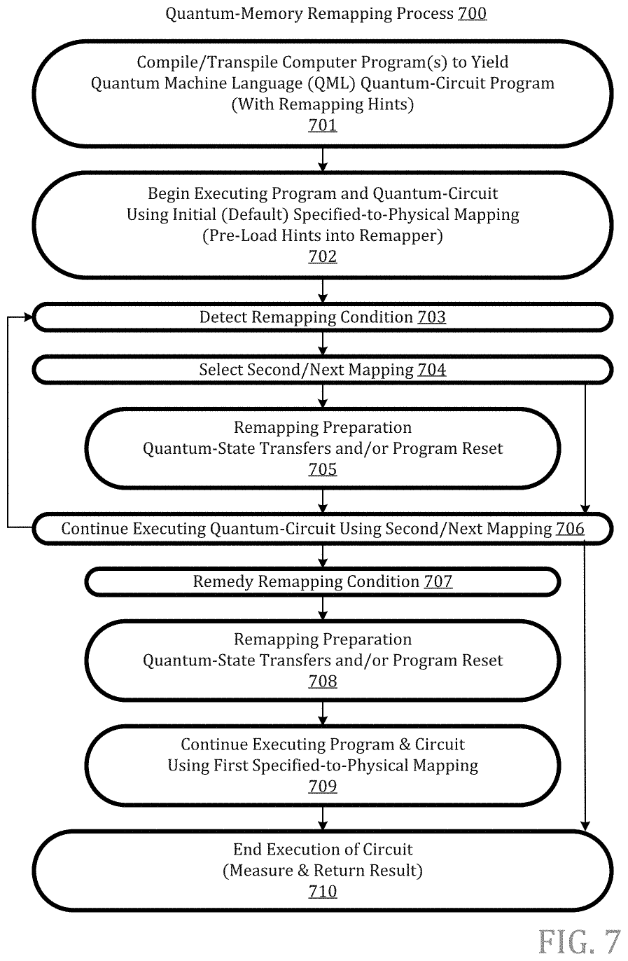

### DETAILED DESCRIPTION

The present invention provides for runtime quantum-memory remapping. During execution of a quantum circuit or other quantum program, a QSC (e.g., a cold atom in a cold-atom quantum computer) can become lost or suffer from some other problem while in place. In response, operations addressing the problematic QSC are remapped to a non-problematic QSC so that program execution can be completed with minimal interruption.

When compared to procedures for replacing a lost QSC, remapping requires less time and involves less risk of unwanted inter-QSC interactions. On the other hand, runtime remapping can be used with QSC replacement to enhance the amount of program progress achieved during QSC replacement, e.g., by moving work away from adversely affected areas of memory. When compared to approaches to error-correction, runtime remapping does not require that most of the QSCs to be devoted to error correction as opposed to program execution. On the other hand, runtime remapping can leverage error correction circuitry to facilitate quantum state transfers across an array.

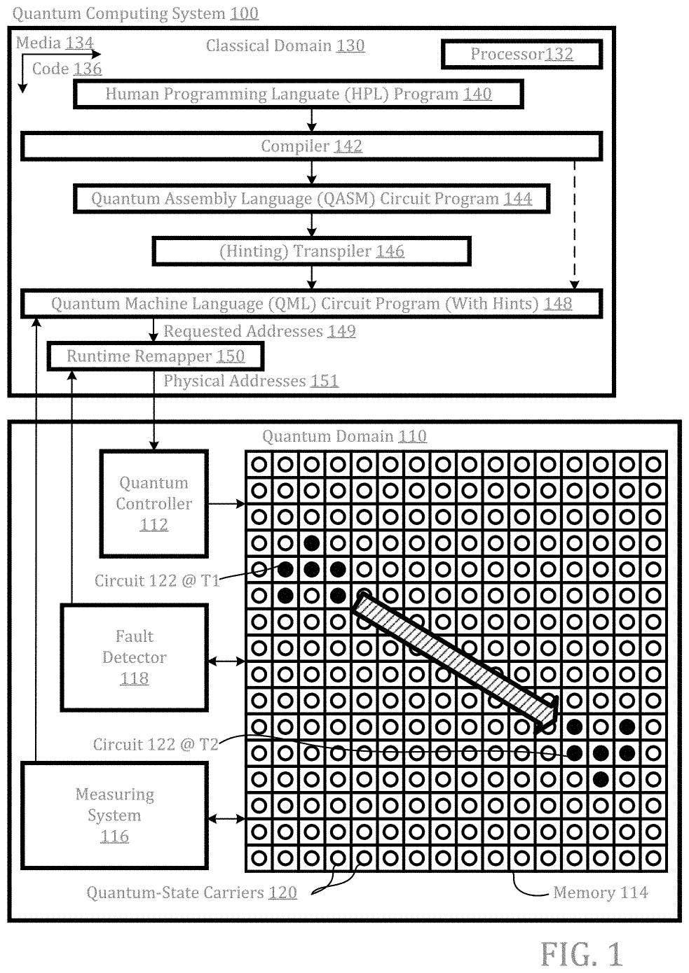

A quantum computing system 100, shown in FIG. 1, can be divided into a quantum domain 110 and a classical domain 130. Quantum domain 102 includes a quantum controller 112, a quantum memory 114, a measuring system 116, and a fault detector 118. Memory 114 is populated with QSCs 120, cold rubidium atoms. At a time T1, a 6-QSC quantum circuit 122 is defined at a first position in memory 114; at a time T2, QSC quantum circuit 122 has been remapped to a second position in memory 114.

Classical domain 130 includes a processor 132 and computer-readable media 134. Media 134 is encoded with code 136, which defines a human programming language (HPL) program 140, a compiler 142, a quantum assembly language (QASM) circuit program 144, and transpiler 146, a quantum machine language (QML) circuit program 148, and a runtime remapper 150.

Herein, a “quantum state carrier” (aka QSC) is a physical object that can assume two or more quantum states; a QSC that can assume either one of exactly two quantum states can be referred to as a “qubit carrier”, while a QSC that can assume any one of exactly three quantum states can be referred to as a “qutrit” carrier, and so on. Herein, a “qubit” is a unit of quantum information capable of assuming a first value, a second value, and a superposition of the first and second values.

Herein, a “quantum gate” is a space-time object that implements a reversible (inputs can be determined from the outputs) quantum operation as its constituent QSCs interact. A “quantum-circuit” is a space-time object constituted by one or more quantum gates arranged to perform a respective circuit function. A “QML quantum-circuit program” is a program that, when executed, causes the quantum circuit to implement its respective function.

Quantum machine language (QML) circuit program 148, when executed using processor 132, streams instructions to quantum controller 112; these instructions specify “requested” memory addresses 149 associated with the position of circuit 122 at time T1, Quantum controller 112 can interpret these instructions and accordingly use its hardware (e.g., lasers) to cause QSCs 120 to interact so as to implement circuit 122. Measuring system 116 can interrogate memory 114 to determine a result of the executed quantum circuit 122; this result can be returned to QML circuit program 148.

Fault detector 118 is designed to detect conditions that could interfere with circuit execution or that might otherwise call for moving or modifying a quantum circuit. Fault detector 118 conveys the information it gathers to runtime remapper 150, which can rewrap requested addresses from QML circuit program 148 to physical addresses 151, in effect, to move at least a part of a quantum circuit top a more satisfactory or desirable location in memory 114. In addition to implementing remappings in response to fault detector 118, remappings can be implement in response to inputs, which in turn can have been automatically or manually triggered for a variety of reasons. For example, a utility circuit design to test memory 114 can be successively rewrapped using remapper 150 to test each of several sections of memory 11.4.

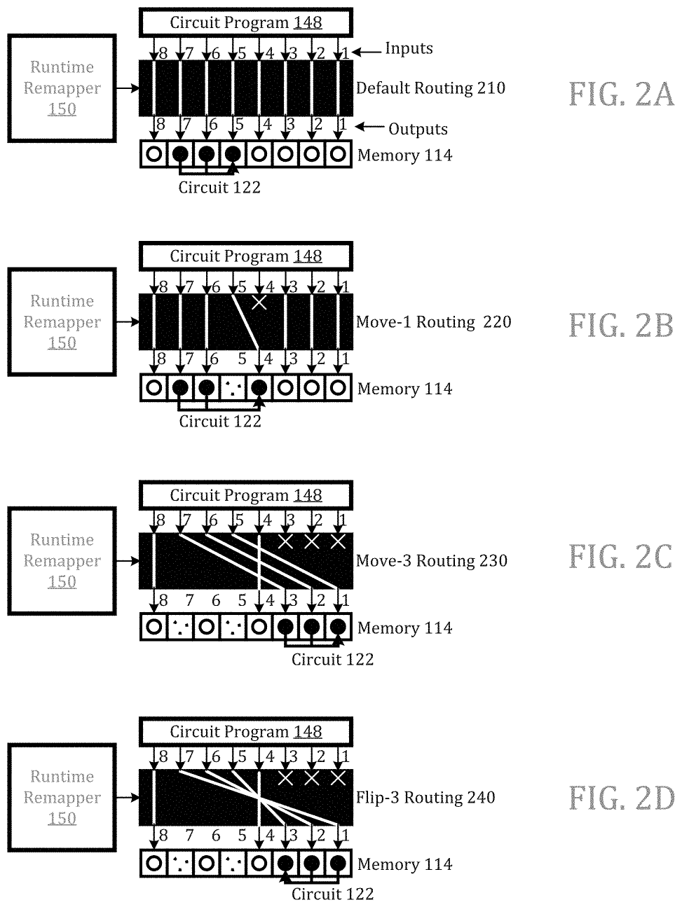

The remapping concept is explained with reference to FIGS. 2A to 2D. For expository purposes, memory 114 is represented in FIGS. 2A to 2D as an 8-QSC linear memory (instead of a 256-QSC two-dimensional quantum memory) and quantum circuit 122 is represented as a 3-QSC linear quantum circuit (instead of a 6-QSC two-dimensional quantum circuit). A default mapping is represented in FIG. 2A implementing a routing 210. Inputs 1-8 are routed respectively to like numbered outputs 1-8, which are connected to physical memory locations 1-8. Given the default configuration, actions specified in QML instructions to be performed at specified locations in memory 114 are, in fact, performed at those locations.

Routing 220, represented in FIG. 2B, remaps circuit 122 as input 5 is rerouted to output 4 (instead of to output 5). The resulting “move-1” configuration, in effect, moves one of the QSCs of circuit 122 over one location in memory 114. The motivation for the move, for example, can have been a loss of a QSC at one of the original memory locations assigned to quantum circuit 122. As a result of this remapping, quantum controller 112 (FIG. 1) applies actions specified for memory location S to the QSC at memory location 4. Actions specified for memory location 4 are not routed to any memory location, but trigger exceptions X to be handled by runtime remapper 150. Note that, while the QSC of circuit 122 are contiguous in the default routing, they are not contiguous in the Move-1 routing.

Unlike routing 220, routing 230, represented in FIG. 2C, preserves the continuous character of circuit 122 by “moving” all three QSC together. Inputs 6, 7 and 8 are routed to outputs 1, 2, and 3, while inputs 1, 2, and 3 are set to trigger exceptions. Routing 240, represented in FIG. 2D is comparable to routing 230, FIG. 2C, except that the circuit 122 is flipped in that the order of its QSC has been reversed. This is roughly analogous to the remapping represented in FIG. 1.

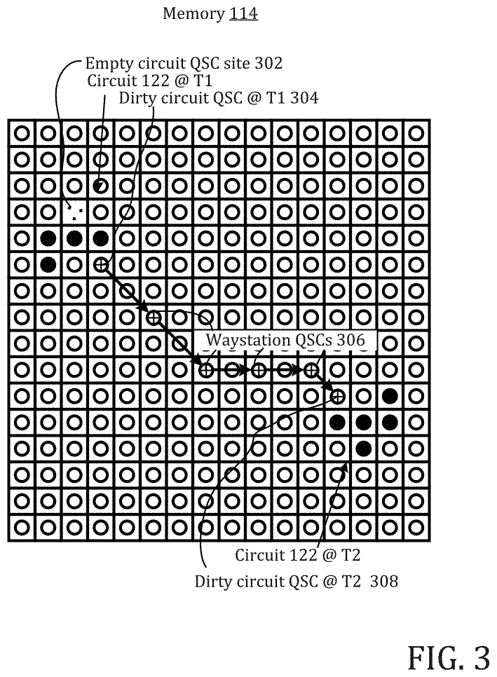

The remapping represented in FIG. 1 is shown modified in FIG. 3. In FIG. 3, an empty circuit QSC site 302 is shown at a location needed by circuit 122 at time T1. In addition, QSC 304 of circuit 122 at time T1 is represented as “dirty”, meaning that it stores information that needs to be retained. Accordingly, a series of five quantum state swaps via waystation QSCs 306 is use to transfer the state of dirty QSC 304 to QSC 308 of circuit 122 at time T2.

The series of state swaps takes time and can pose challenges regarding unwanted interactions with QSCs near the state swap path. The number of waystations can be reduced by using longer range state swap interactions, but, as these require greater power, they also carry an increased challenge regarding unwanted QSC interactions. Alternatives to state swap operations include recomputing, a QSC value, which can be time consuming, and using a modified error-correction scheme, which can be resource intensive. Therefore, all else being equal, it can be preferable to select remappings that do not require or at least minimize state swap operations.

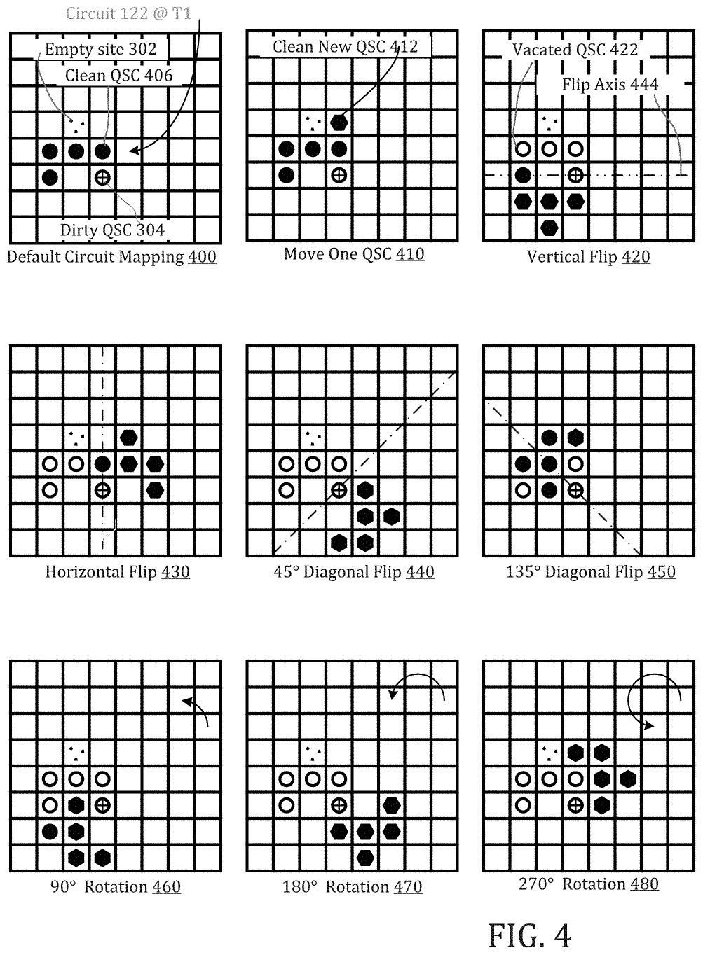

Quantum circuit remappings that do not remap an included dirty QSC can obviate the need for state-swap operations and recomputing QSC values as explained with respect to certain scenarios represented in FIG. 4. Circuit 122 at time T1 is shown in the context of an upper left quadrant of memory 114 in its default circuit mapping 400 at the top-left of FIG. 4. Six-QSC Circuit 122 is shown including four “clean” QSCs 406 that do not include information that must be preserved in a mapping, and one “dirty” QSC 304. One QSC of circuit 122 is not shown as the memory site 302 that is supposed to contain that QSC is empty, which is a motivation for remapping circuit 122.

A move-one QSC remapping 410 is shown at the top-center of FIG. 4. A new QSC 412 is added to circuit 122 to compensate for the QSC lost from site 302. This remapping does not require movement of the dirty QSC 304 or any of the claim QSCs 406. On the other hand, move-one-QSC remapping 410 changes the shape of circuit 122 and, thus, can result in a greater separation between QSCs that need to interact. The greater interaction strengths that may be needed to ensure interactions between the more distant QSCs can increase the risk of unwanted interactions with other QSCs. Also, the proximity of new QSC 412 to the empty site may interfere with the loading of a new QSC at empty site 302. Thus, while the general approach of simply adding neighboring QSCs to a circuit to replace missing or defective QSCs of the default circuit mapping may be the best approach in many scenarios, other approaches may be more suitable in alternative scenarios.

A vertical flip remapping, shown at the top right of FIG. 4 preserves the shape of circuit 122. (Herein, a “flip” is a rotation out of the plane of the two-dimensional memory 114 about an axis 444 in the plane of the of memory 114.) Thus, there are no increased QSC separations and thus no associated need to increase interaction strengths. Also, none of the QSCs along the flip axis are moved, which can be useful for cases where two or more dirty QSCs lie along a flip axis. Also, for this particular circuit and scenario, the QSCs 422 nearest to empty site 302 are no longer in circuit 122, so there is less risk of a problem reloading empty site 302. In the illustrated case, the vertical flip remapping 420 introduces four new QSCs to circuit 122 (in contrast to the one new QSC for move-one-QSC mapping 410. There may be advantageous or disadvantages to vertical flip remapping 420 depending on the scenario (e.g., conflicting assignments of QSCs in the vicinity).

Three additional “flip” remappings are shown in the second, i.e., middle, row of FIG. 4: horizontal flip remapping 430, a 45° diagonal flip remapping 440, and a 135° diagonal flip mapping 450. Three in-plane rotations (about axes orthogonal to the memory plane) are shown in the bottom row of FIG. 4: a 90° counterclockwise rotation remapping 460, an 180° rotation remapping 470, and a 270° counterclockwise rotation remapping 480. Which of the eight remappings shown in FIG. 4 is best depends on the scenario, and each may serve as a starting point of a remapping that also involves translation and or movement of individual QSCs (as in move-one QSC remapping 410).

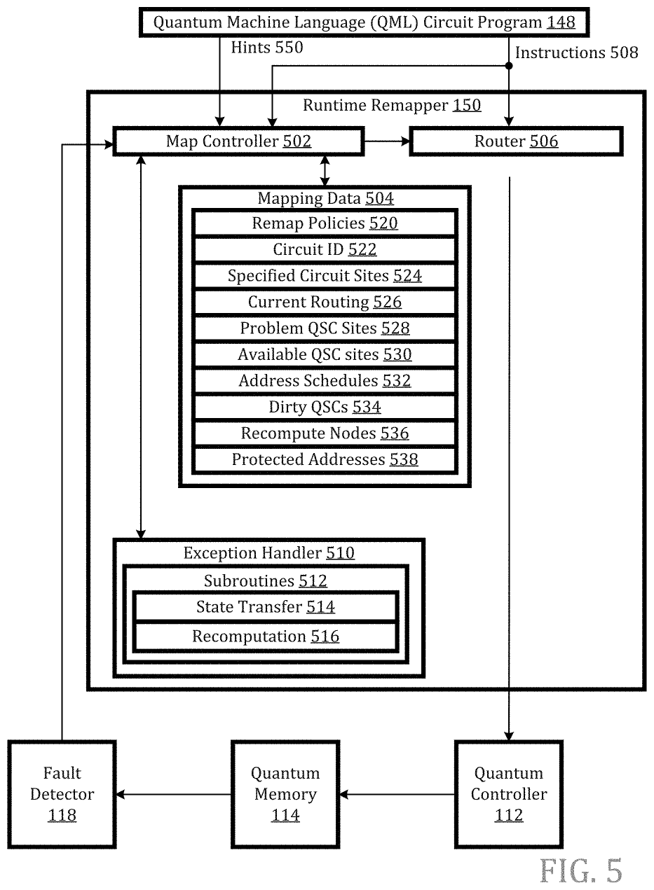

Runtime remapper 150, as shown in FIG. 5, includes a map controller 502 that selects a remapping based on; 1) information from fault detector 118 regarding the nature of a detected fault; and 2) mapping data 504. Map controller 502 controls a router 506, which can be a programmable look-up table (LUT) corresponding to the selected remapping. Router 506 receives instructions 508 from QML circuit program 148, uses the associated requested addresses as LUT inputs, and routes the instructions according to the LUT outputs. Map controller 502 can access an exception handler 510 to handle actions that must be taken before a remapping can be used. For example, exception handler 510 includes subroutines 512, e.g., to implement state transfers 514 (using quantum state swaps) and recomputations 516.

Mapping data 504 includes remap policies 520, circuit identities 522, specified circuit sites 524, current routing 526, problem QSC sites 528, available QSC sites 530, address schedules QSCs 532, dirty QSCs 534, recompute nodes 536, and protected addresses 538. Remap policies 520 include algorithms for generating selected and candidate remappings as well as for comparatively evaluating candidate remapping. The algorithms accept data of the other types included in mapping data 504.

Circuit identities 522 specify for each specified address and each memory location the associated circuit for scenarios in which circuits are implemented concurrently. This information is used to determine which instructions to re-execute to recompute a QSC value. In addition, this information is used to route results to the appropriate one of currently run circuits. Circuit identities 522 can be provided using program hints.

Specified circuit sites 524 indicates those memory sites that are specified as the locations for QSCs that belong to a circuit, or, in other words, used in the default routing; this information can be extracted as addresses are asserted by QML circuit program 148 or they can be presented in advance using hints 550 from circuit program 148. Current routing 526 identifies the memory sites to which addresses are actually mapped either by a default routing or a remapped routing; this information is known because map controller 502 selects the routing.

Problem QSC sites 528 lists memory locations identified as faulty or otherwise problematic by fault detector 118; these are typically sites from which circuits are to be remapped. Available QSC sites 530 lists memory sites to which no specified memory addresses have been mapped. This list can be built up based upon addresses encountered in stream, in which case some of the available memory addresses may end up being unavailable as execution progresses. Alternatively, the available memory sites can be determined based on an upfront hint 550 as modified by the current routing 526. In the latter case, address schedules 532, (which indicate when addresses are scheduled to become available or unavailable) can be used to identify sites that may be available temporarily.

Dirty QSCs 534 identifies memory locations with QSCs that have information that should be preserved during a remapping or else recomputed before executing a remapped circuit. Recompute nodes 536 identify on a per-QSC basis, an instruction in AML circuit program 148 from which the value of a dirty QSC can be recomputed. In general, QSC values can be recomputed by restarting circuit program 148; however, to save time and to avoid recomputing values that do not need to be recomputed, recompute nodes 536 can identify less burdensome points from which to recompute.

Finally, protected addresses 538 are addresses for which remapping is prohibited. For example, all memory locations associated with a circuit designed to validate specific memory locations may only be useful at its specified memory locations. The protected status may be specified in high-level human programming language and then preserved through compiling and transpiling.

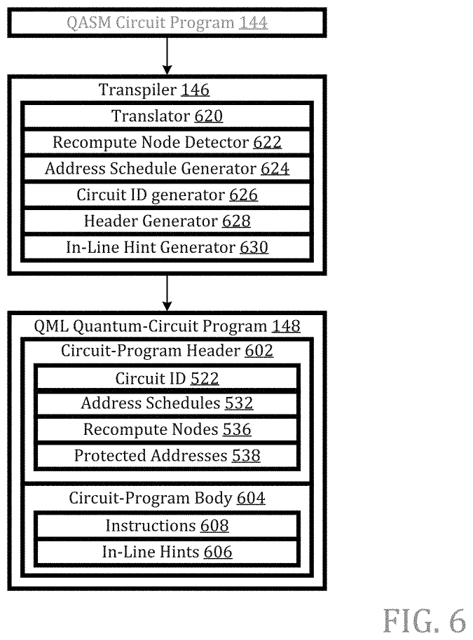

Hints 550, from which much of mapping data 504 can be derived, can from a header 602 and/or a body 604 of QML circuit program 148, as shown in FIG. 6. In circuit program body 604, in-line hints 606 an be interspersed, e.g., as no-ops, with program instructions 608. Header 602 can provide up-front map data, e.g., circuit Identities 522, address schedules 532, recompute nodes 536, and protected addresses 538.

QML circuit program 148 results from transpiling QASM circuit program 144. QASM circuit program 144 defines logical quantum circuits in an assembly language that is independent of any specific quantum technology (e.g., superconductors vs. cold atoms). A “transpiler” is defined as a compiler for which the source and target programs are at a similar level of abstraction.

Transpiler 146 includes a translator 620, a recompute node detector 622, an address schedule generator 624, a circuit ID generator 626, a header generator 628, and an in-line hint generator 630. Translator 620 converts the machine-independent instructions of QASM circuit program 144 to instructions 508 that are interpretable by quantum controller 112 (FIG. 5). Recompute node detector 622 scans instructions 608 to identify recompute nodes 536. Address schedule generator 624 scans instructions 608 to generate address schedules 532. Circuit ID generator 626 generates a unique identifier for each circuit processed by transpiler 146. Header generator 628 generates header 602 to provide hints up front, while in-line hint generator provides hints that are best suited to locations in the instruction stream.

A quantum memory remapping process 700, flow-charted in FIG., 7, provides for runtime remapping of addresses specified by a quantum-circuit program to QSCs of a quantum memory. At 701, computer programs are compiled (e.g., transpiled) to yield quantum machine language (QML) quantum circuit programs. Quantum circuit programs can include remapping hints that can provide information useful for selecting optimal remappings in many cases.

At 702, execution of the quantum-circuit program and, consequently, execution of the quantum circuit defined by that program begin. If the quantum-circuit program contains header hints, these can be loaded into a runtime remapper. An initial mapping of addresses specified by the quantum-circuit program to physical memory locations can be implemented; typically, a default mapping is used mapping specified addresses to the memory locations they specify.

At 703, a remapping condition is detected. This can involve detecting a vacated memory site that is supposed to be occupied by a QSC associated with the (quantum circuit given the current mapping). Alternatively, error detection circuitry may detect one or more computational errors in or around a QSC of the circuit. In some scenarios, a circuit or at least part of a circuit may need to be remapped because memory locations that it occupies may need to be repurposed, e.g., taken over by a higher priority quantum circuit.

At 704, a new mapping is selected. During a first iteration, this mapping is a second mapping. However, if there has already been a remapping during execution of the quantum-circuit program, this will still be the “next” remapping. Normally, the mapping is to memory locations that are “available” in that the resident QSCs are not assigned to a quantum circuit. As shown in the examples of FIG. 4, some QSCs of a circuit may retain their QSCs, which may avoid an otherwise required quantum state transfer. Also, as shown in FIG. 4, e.g., with respect to the 135 diagonal flip 450, some QSCs may exchange positions with other QSCs of the same circuit or occupy locations of other QSCs of the same circuit that have been moved elsewhere. In some cases, memory locations that were not available may become available as their occupants (e.g., other circuits) are repurposed.

At 705, actions required before resuming program execution are carried out. For example, quantum state swaps can be used to preserve quantum information associated with a dirty QSC that has been remapped. Otherwise, lost information can be recomputed, e.g., by resetting the quantum-circuit program to restart from the beginning or from some intermediate recompute node.

At 706, execution of the program and the circuit are resumed or simply continued using the new mapping. (In some cases, the remapping may not require halting execution, so execution can continue without being resumed.) In the event no remapping preparation is required, action 706 can follow action 704 instead of action 705. In the event another remapping condition is detected, actions 703-706 can be repeated (as many times as necessary).

In some embodiments, the program is completely compiled to hardware code, e.g., laser pulse timing, duration, shape, frequency, and direction. In such embodiments, unexecuted hardware code may be discarded (flushed). Program instructions can then be resent and remapped to replace the discarded code. Other embodiments apply remapping to the hardware code in the hardware-code queue or as it is fetched for execution.

In some embodiments, a remapping condition can be remedied, e.g., by replacing a lost QSC, at 707. In that case, remapping preparation similar to that at 705 can be implemented at 708, and execution can continue at 709 using the first mapping. Execution of the circuit can end at 710, either after 705 or 709. After circuit execution is completed, a measurement can extract a result, which can be returned to the program or elsewhere.

Herein, “runtime” extends from the beginning of execution of the quantum circuit to completion of the execution of the quantum circuit. The quantum circuit program that defines the quantum circuit may begin earlier and may end later. In the illustrated embodiments, the memory is a single quantum register in the form of a square array. Other embodiments provide for one-dimensional arrays, other two-dimensional arrays, and three-dimensional arrays. Embodiments provide for memories using two or more registers; depending on the embodiment, the different registers may be based on the same technology or different technologies, e.g., cold atom versus superconductor, to leverage the advantages of each.

Herein, all art labeled “prior art”, if any, is admitted prior art; all art not labeled “prior art”, if any, is not admitted prior art. The illustrated embodiments, variations thereupon and modifications thereto are provided for by the present invention, the scope of which is defined by the following claims.

What is claimed is:

1. A runtime quantum-memory remapping process comprising:
beginning execution of a quantum circuit using a first mapping of specified addresses to physical quantum memory locations, the specified addresses being specified by a quantum-circuit program that defines the quantum circuit, the first mapping routing a first specified address to a first physical memory location;
after the beginning of execution, remapping the specified address to quantum-memory locations to implement a second mapping, the second mapping routing the first specified address to a second physical memory location different from the first physical memory location;
after the remapping, continuing execution of the quantum circuit using the second mapping; and
completing execution of the quantum circuit.

2. The runtime quantum-memory remapping process of claim 1 further comprising detecting a remapping condition, the remapping being in response to the detecting the remapping condition.

3. The runtime quantum-memory remapping process of claim 1 further comprising, prior to continuing execution of the quantum circuit, transferring a quantum state of a first quantum-state carrier at the first physical memory location to a second quantum-state carrier at the second physical memory location.

4. The runtime quantum-memory remapping process of claim 1 further comprising, prior to continuing execution of the quantum circuit, recomputing a value at the second physical memory location that was previously computed for the first physical memory location.

5. The runtime quantum-memory remapping process of claim 1 wherein the first mapping maps a second specified address to a third physical memory location, and the second mapping maps the second specified address to the third physical memory location.

6. The runtime quantum-memory remapping process of claim 5 wherein the third physical memory location stores a dirty quantum-state carrier at the time of the remapping.

7. The runtime quantum-memory remapping process of claim 1 further comprising remedying the remapping condition and restoring the first mapping prior to completing execution of the quantum circuit.

8. A system comprising, computer-readable memory encoded with code that, when executed using a processor, executes a process including:
beginning execution of a quantum circuit using a first mapping of specified addresses to physical quantum memory locations, the specified addresses being specified by a quantum-circuit program that defines the quantum circuit, the first mapping routing a first specified address to a first physical memory location;
after the beginning of execution, remapping the specified address to quantum-memory locations to implement a second mapping, the second mapping routing the first specified address to a second physical memory location different from the first physical memory location;
after the remapping, continuing execution of the quantum circuit using the second mapping; and
completing execution of the quantum circuit.

9. The system of claim 8 wherein the process further includes detecting a remapping condition, the remapping being in response to the detecting the remapping condition.

10. The system of claim 8 wherein the process further includes, prior to continuing execution of the quantum circuit, transferring a quantum state of a first quantum-state carrier at the physical memory location to a second quantum-state carrier at the second physical memory location.

11. The system of claim 8 wherein the process further includes, prior to continuing execution of the quantum circuit, recomputing a value at the second physical memory location that was previously computed for the first physical memory location.

12. The system of claim 8 wherein the first mapping maps a second specified address to a third physical memory location, and the second mapping maps the second specified address to the third physical memory location.

13. The system of claim 12 wherein the third physical memory location stores a dirty quantum-state carrier at the time of the remapping.

14. The system of claim 8 wherein the process further includes remedying the remapping condition and restoring the first mapping.

15. The system of claim 8 further comprising the processor.
